(19) United States
(12) Patent Application Publication
(10) Pub. No.: US 2023/0316437 A1
(43) Pub. Date: Oct. 5, 2023

(54) GENERATING USER-SPECIFIC INCENTIVES FOR VOYAGES BASED ON USER HEALTHCARE SKILLS

(71) Applicant: Optum, Inc., Minnetonka, MN (US)

(72) Inventors: Abhay Shukla, Noida (IN); Ramprasad Anandam Gaddam, Mumbai (IN); Shailaja Daral, Gurugram (IN)

(21) Appl. No.: 17/657,298

(22) Filed: Mar. 30, 2022

(51) Int. Cl. G06Q 50/14; G06Q 10/02; G06Q 30/02

(52) U.S. Cl. CPC G06Q 50/14; G06Q 10/02; G06Q 30/0222

(57) ABSTRACT

An example method for generation of travel-booking user interfaces, the method including receiving, by a computing system, a user interface request to present to a user a travel-booking user interface that indicates one or more available voyages from an originating location to a destination location, determining, by the computing system and for each respective voyage of the one or more available voyages, a user-specific incentive for the respective voyage that is based at least in part on applicable healthcare skills of the user and health metrics of passengers that are already booked for the respective voyage, wherein the applicable healthcare skills include healthcare skills that are applicable to an in-voyage medical emergency, and generating, by the computing system and based on the user interface request, the travel-booking user interface based on the determined user-specific incentive.

### TECHNICAL FIELD

The disclosure relates to generating website user-interfaces.

### BACKGROUND

Passengers on various voyages regularly experience in-voyage medical emergencies which may be difficult for crew members to respond to and may require diversion of the voyage in order to provide proper assistance to the passenger experiencing the in-voyage medical emergency. In some examples, some of the passengers may have applicable healthcare skills and may be able to address the in-voyage medical emergency without requiring diversion of the voyage.

### SUMMARY

In general, the present disclosure describes systems and methods for generating a travel-booking user interface in response to a request from a user. The travel-booking user interface displays to the user one or more user-specific incentives corresponding to one or more applicable voyages between an originating location and a destination location. Each user-specific incentive may be designed to incentivize the user to book a seat on the respective voyage and may be generated based on the applicable healthcare skills of the user and the health metrics of the passengers already booked for the respective voyage.

In one example, a method for the generation of travel-booking user interfaces comprises: receiving, by a computing system, a user interface request to present to a user a travel-booking user interface that indicates one or more available voyages from an originating location to a destination location; for each respective voyage of the one or more available voyages, determining, by the computing system, a user-specific incentive for the respective voyage that is based at least in part on applicable healthcare skills of the user and health metrics of passengers that are already booked for the respective voyage, wherein the applicable healthcare skills include healthcare skills that are applicable to an in-voyage medical emergency; and based on the user interface request, generating, by the computing system, the travel-booking user interface based on the determined user-specific incentive.

In another example, a computing system comprises: memory; and processing circuitry configured to: receive a user interface request to present to a user a travel-booking user interface that indicates one or more available voyages from an originating location to a destination location; for each respective voyage of the one or more available voyages, obtain a user-specific incentive for the respective voyage that is based at least in part on applicable healthcare skills of the user and health metrics of passengers that are already booked for the respective voyage, wherein the applicable healthcare skills include healthcare skills that are applicable to an in-voyage medical emergence, and wherein the applicable healthcare skills of the user and the health metrics of the passengers are stored in the memory; and based on the user interface request, generate the travel-booking user interface based on the determined user-specific incentive.

In another example, a non-transitory computer readable medium comprises instructions that, when executed, cause processing circuitry of a computing system to: receive a user interface request to present to a user a travel-booking user interface that indicates one or more available voyages from an originating location to a destination location; for each respective voyage of the one or more available voyages, obtain a user-specific incentive for the respective voyage that is based at least in part on applicable healthcare skills of the user and health metrics of passengers that are already booked for the respective voyage, wherein the applicable healthcare skills include healthcare skills that are applicable to an in-voyage medical emergency; and based on the user interface request, generate the travel-booking user interface based on the determined user-specific incentive.

The details of one or more examples are set forth in the accompanying drawings and the description below. Other features, objects, and advantages will be apparent from the description and drawings, and from the claims.

### BRIEF DESCRIPTION OF DRAWINGS

Reference is made to the attached drawings, wherein elements have the same reference numeral designations represent similar elements throughout.

FIG. 1 is a conceptual diagram illustrating an example user-interface generation system including a computing system configured to communicate information between a user and a third-party computing system.

FIG. 2 is a functional block diagram illustrating an example configuration of the computing system of FIG. 1.

FIG. 3 is a flowchart illustrating an example process of generating a travel-booking user interface in response to a request from a user.

FIG. 4 is a flowchart illustrating an example process of determining user-specific incentives for a voyage.

FIG. 5 is a flowchart illustrating an example process of updating user-specific incentives for a voyage in response to changes in the bookings for the voyage.

FIG. 6 is a flowchart illustrating an example process of determining user-specific incentives for a voyage based on the applicable healthcare skills of other persons on the voyage.

FIG. 7 is an example user interface displayed on a user device to receive a user interface request from the user to present a travel-booking user interface.

FIG. 8 is an example travel-booking user interface generated by a computing system based on a plurality of user-specific incentives corresponding to a plurality of voyages.

### DETAILED DESCRIPTION

The disclosure generally describes systems and methods for generating a travel-booking user interface in response to a request from a user. The travel-booking user interface displays one or more user-specific incentives corresponding to one or more applicable voyages between an originating location and a destination location. A computing system may determine a user-specific incentive for each respective voyage of the applicable voyages based on the applicable healthcare skills of the user and health metrics of passengers already booked for the respective voyage. The user-specific incentives are configured to incentivize the user to book a seat on the respective voyage. The user-specific incentives may include monetary incentives (e.g., a discount on the booking price, discounts to other events, or the like) or non-monetary incentives (e.g., free additional luggage, free premium lounge access, or the like).

In some voyages, passengers may experience in-voyage medical emergencies which may be difficult for crew members to respond to due to a lack of experience and/or applicable healthcare skills. In-voyage medical emergencies may include events in which one or more individuals (e.g., passengers or crew members) experience a medical condition that may require medical assistance (e.g., medication, professional assistance, or the like) to address. In such situations where the crew members are unable to address the medical emergency, the crew members may need divert the voyage to a nearby location, e.g., to a nearby railroad station, airport, seaport, or the like, to provide the necessary medical treatment to the individual experiencing the in-voyage medical emergencies (IMEs), e.g., via emergency medical services (EMS). The diversion of the voyages may lead to significant financial and non-financial losses for the owners and/or operators of the affected voyages. Non-financial losses may include risk of lawsuits, loss of customer loyalty, damage to the reputation of the operators, and the like. If one or more passengers and/or crew members have applicable healthcare skills and may provide applicable medical aid to the individual experiencing the in-voyage medical emergency, the number of diverted voyages may be reduced.

If the owners and/or operators of the voyages receive information regarding the healthcare skills of the passengers and crew members and the health metrics (e.g., medical conditions) for each respective voyage, the operators may be able to allocate the passengers and crew members with applicable healthcare skills amongst the available voyages in a manner which may reduce the number of diverted voyages due to in-voyage medical emergencies. The example systems and methods of this disclosure may facilitate the allocation passengers with healthcare skills to appropriate voyages by determining and providing user-specific incentives to users based at least in part on applicable healthcare skills and health needs of passengers for each respective voyage.

The example systems and methods may provide one or more technical advantages. For example, the example systems and methods may provide a means of improving the efficiency of the allocation, by a computing system and/or device, of individuals with applicable healthcare skills amongst available voyages to reduce the number of diverted voyages. In some examples, the example systems and methods may improve the efficiency of the allocation, by a computing system, of voyage crew members with applicable healthcare skills amongst the available voyages to reduce the number of diverted voyages. The example systems and methods may also improve the efficiency of the allocation, by a computing system, of a set quantity of incentives (e.g., monetary incentives, non-monetary incentives) amongst prospective passengers with healthcare skills to reduce the number of diverted voyages. The example systems and methods may also provide a better user interface to the user by presenting the user-specific incentives for the available voyages. The user-specific incentives presented in the user interface may increase the likelihood that the user may book one of the available voyages which increases the effectiveness of the user interface in attracting prospective passengers and reducing the number of diverted voyages.

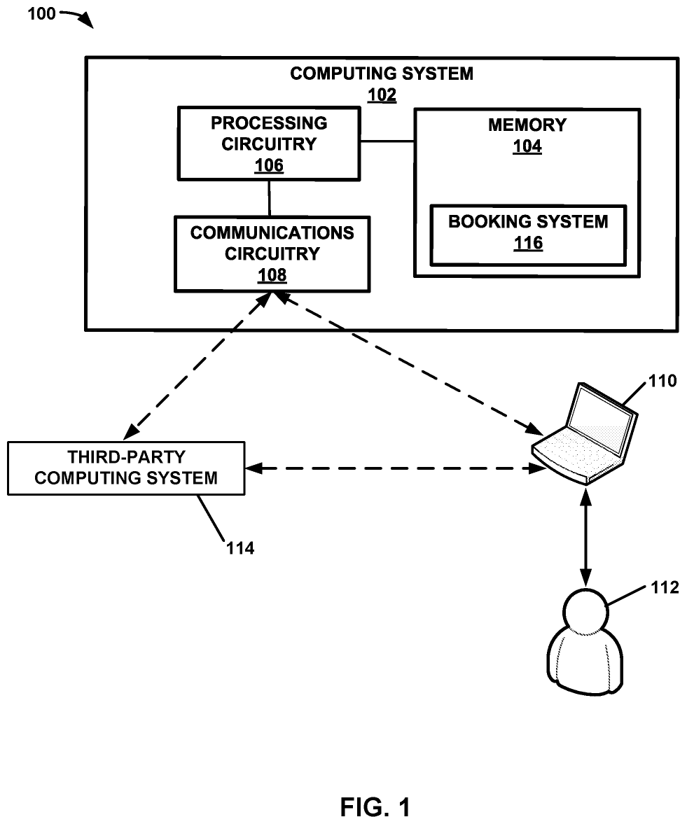

FIG. 1 is a conceptual diagram illustrating an example user-interface generation system 100 including a computing system 102 configured to communicate information between user device 110 of user 112 and a third-party computing system 114, in accordance with one or more techniques of this disclosure.

User device 110 may include, but is not limited to, portable or mobile devices such as mobile phones (including smart phones), laptop computers, tablet computers, wearable computing devices such as smart watches or computerized eyewear, smart television platforms, cameras, personal digital assistants (PDAs), etc. In some examples, user device 110 may include stationary computing devices such as desktop computers, servers, mainframes, etc.

Computing system 102 may contain components including memory 104, processing circuitry 106, and communications circuitry 108. Memory 104 may contain booking system 116 configured to generate user interface for user 112. While computing system 102 as illustrated in FIG. 1 only includes memory 104, processing circuitry 106, and communications circuitry 108, other example computing systems may include additional components (e.g., control circuitry, arithmetic and logic circuitry, or the like). The additional components may be configured to perform at least some of the techniques disclosed herein. Memory 104, processing circuitry 106 and communications circuitry 108 may communicate with each other. In some examples, computing system 102 may be a single computing device. In some examples, computing system 102 may be located within user device 110, e.g., as part of an application on user device 110. In other examples, computing system 102 may be one or more computing devices. In other examples, computing system 102 may be a cloud computing system.

Processing circuitry 106 comprises circuitry configured to perform processing functions. For instance, processing circuitry 106 may include one or more microprocessors, application-specific integrated circuits (ASICs), field-programmable gate arrays (FPGAs), or other types of processing circuitry. In some examples, processing circuitry 106 of computing system 102 may read and may execute instructions stored by memory 104 (e.g., in booking system 116). Processing circuitry 106 may be included in a single device (e.g., user device 110), or distributed among multiple devices.

Communications circuitry may enable computing system 102 to send data to and receive data from one or more other computing devices, e.g., via a communications network, such as a local area network or the Internet. In some examples, communications circuitry 108 may include wireless transmitters and receivers that enable computing system 102 to communicate wirelessly with other computing devices. Examples of communications circuitry 108 may include network interface cards, Ethernet cards, optical transceivers, radio frequency transceivers, or other types of devices that are able to send and receive information. Other examples of such communications units may include BLUETOOTH™, 3G, 4G, 5G, WI-FI™ radios, Universal Serial Bus (USB) interfaces, etc. Computing system 102 may use communications circuitry 108 to communicate with one or more other computing devices or systems, such as user device 110, third-party computing system 114, or the like. Communications circuitry 108 may be included in a single device (e.g., user device 110) or distributed among multiple devices.

In the example of FIG. 1, computing system 102 receives a user interface request to present to user 112 a travel-booking user interface. Computing system 102 may receive the user interface request via user device 110. The travel-booking user interface may indicate a one or more available voyages from an originating location to a destination location. User 112 may make a request through a webpage or through an interface in an application on user device 110. As part of the user interface request, user 112 may enter a plurality of input parameters indicating the types of voyages user 112 is searching for. The input parameters may include parameters of a prospective voyage including, but are not limited to, the originating location, the destination location, the date of the voyage, the number of passengers, special accommodations, the mode of transportation, and the like.

User device 110 may communicate the user interface request to computing system 102 (e.g., through communications circuitry 108 of computing system 102). In response to the user interface request, processing circuitry 106 may retrieve and execute instructions from memory 104 (e.g., booking system 116 of memory 104) to generate the travel-booking user interface for user 112. Processing circuitry 106 may then instruct communications circuitry 108 to transmit the travel-booking user interface to user device 110 for display to user 112. The user interface may contain one or more user-specific incentives corresponding to one or more available voyages displayed on the travel-booking user interface. The user-specific incentives may be monetary incentives (e.g., discounts on prices of voyages) and/or non-monetary incentives (e.g., access to exclusive lounges, free additional luggage, extra customer loyalty points, and the like) configured to incentivize user 112 to book a seat on one or more of the available voyages. For each respective voyage of the one or more available voyages, computing system 102 may determine a user-specific incentive for the respective voyage that is based at least in part on applicable healthcare skills of user 112 and health metrics of passengers that are already booked for the respective voyage. The applicable healthcare skills may include healthcare skills that are applicable to an IME. In some examples, computing system 102 may generate, based on the user interface request, the travel-booking user interface based on the determined user-specific incentives.

Processing circuitry 106 may determine a plurality of available voyages that satisfy the inputted parameters of user 112. Processing circuitry 106 may determine a voyage satisfies the inputted parameters of user 112 if one or more available seats on the voyage satisfy the inputted parameters of user 112. Processing circuitry 106 may retrieve information regarding the available seats on the voyage from memory 104, another computing device and/or system, a cloud computing environment, and the like. Processing circuitry 106 may, as part of generating the travel-booking user interface, obtain data indicating the applicable healthcare skills of user 112, data on health metrics of the other passengers for each voyage, and/or instructions stored in booking system 116 from memory 104 to generate user-specific incentives for each voyage. Processing circuitry 106 may generate the user-specific incentives for each respective voyage based at least in part on applicable healthcare skills of user 112 and health metrics of the passengers already booked for the respective voyage. In some examples, computing system 102 may retrieve the data from user device 110, third-party computing system 114, or other similar computing device and/or system.

Third-party computing system 114 may include one or more computing devices, a cloud computing environment, or other similar computing device and/or system corresponding to one or more third-parties. Third-parties may include owners of one or more of the available voyages, operators of one or more of the available voyages, crew members of one or more of the available voyages, travel insurance companies, staff members of transportation stations (e.g., railroad stations, bus stations, harbors, airports, and the like), and other relevant parties. In some examples, third-party computing system 114 may store the healthcare skills of user 112, health metrics of passengers, or other relevant information. Computing system 102 may retrieve the information from third-party computing system 114 as a part of generating the travel-booking user interface. In some examples, computing system 102 may transmit the healthcare skills of user 112, the health metrics of passengers for each respective voyage of the one or more available voyages, and/or the user-specific incentive for the respective voyage to third-party computing system 114 (e.g., to a computing device corresponding to the third party), e.g., to prepare the third party for any potential medical emergencies, to inform the third party of any potential risks regarding the passengers, and the like. In some examples, computing system 102 may remove any identifying information prior to transmitting the healthcare skills of user 112 and/or the health metrics of passengers to third-party computing system 114.

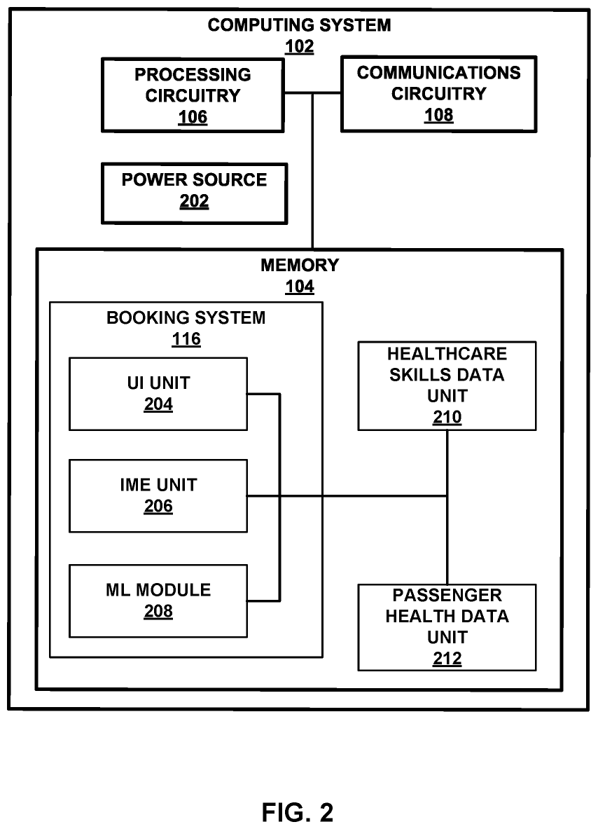

FIG. 2 is a functional block diagram illustrating an example configuration of computing system 102 of FIG. 1. Computing system 102 may include memory 104, processing circuitry 106, communications circuitry 108, and power source 202. Memory 104 may include booking system 116, which may include a user interface (UI) unit 204, in-voyage medical emergency (IME) unit 206, and machine learning (ML) module 208. In some examples, as illustrated in FIG. 2, memory 104 may include healthcare skills data unit 210 and passenger health data unit 212. In other example configurations of computing system 102, computing system 102 may include additional components (e.g., a user interface, sensing circuitry, and the like). One or more of the actions described in this disclosure as performed by booking system 116 (e.g., UI unit 204, IME unit 206, ML module 208, or the like), healthcare skills data unit 210, passenger health data unit, and the like may be performed by processing circuitry 106 when executing instructions associated with such units.

In some examples, computing system 102 may receive data indicating the healthcare skills of user 112, e.g., via user device 110, as a part of receiving a user interface request from user device 110. In other examples computing system 102 may receive data indicating the healthcare skills of user 112 separately from receiving the user interface request from user device 110. For example, computing system 102 may obtain data indicating the healthcare skills of user 112 prior to receiving the user interface request. The healthcare skills may include, but are not limited to, healthcare experience, healthcare training, healthcare education, and specialized field of practice. Computing system 102 may store the data indicating the healthcare skills of user 112 in healthcare skills data unit 210 of memory 104.

In some examples, computing system 102 may obtain data corresponding to the health metrics of the prospective passengers as a part of booking a seat on a voyage via one or more computing devices, e.g., via a survey, a questionnaire, or the like. In some examples, computing system 102 may obtain the data corresponding to the health metrics of the passengers from one or more computing devices corresponding to the passengers, e.g., at a time prior to the booking of a seat on a voyage, e.g., during a booking for a previous voyage. In some examples, computing system 102 may receive the health metrics of the prospective passengers from a third-party computing system 114 (e.g., a wearable fitness device, a fitness and/or wellness center passenger is attending, mobile fitness and/or health applications, and the like). The health metrics of the passengers may include, but are not limited to, current illnesses and/or injuries, past illnesses and/or injuries, family history of illnesses, current medications, surgical history, vaccination history, past IMEs, and recent biometric screening results (e.g., results of a recent medical checkup). Computing system 102 may store data corresponding to the health metrics of the passengers in memory 104 (e.g., in passenger health data unit 212). Computing system 102 may obtain the data from memory 104 at a later time, e.g., in response to a user interface request.

Upon reception of an user interface request, IME unit 206 may determine potential in-voyage medical emergencies (IMEs) for each voyage. IMEs may include, but are not limited to, medical conditions such as syncope, pre-syncope, gastro-intestinal (GI) symptoms, respiratory symptoms, cardiovascular issues, seizures and/or postictal states, psychiatric conditions, allergic reactions, strokes, diabetes complications, obstetric emergencies, cardiac arrests, and so on that occur during a voyage. IME unit 206 of booking system 116 may determine potential IMEs for a voyage by determining the likelihood that each of the passengers will experience one or more of the IMEs during the voyage based on the health metrics of the passenger. IME unit 206 may identify if a particular medical condition is likely to cause an IME using published medical information, historical IME data, or by applying a self-learning model.

For each of the passengers, IME unit 206 may assign a passenger IME risk score to the passenger to represent the likelihood that the passenger will experience one or more IMEs. The passenger IME risk score may represent the likelihood of the occurrence of an IME during the voyage weighed by the potential severity of the IME. For example, IME unit 206 may give a potential occurrence of minor GI symptoms less weight than a potential occurrence of a cardiac arrest when assigning a passenger IME risk score to the passenger. In some examples, IME unit 206 may assign a higher passenger IME risk score to passengers with a history of past IMEs than other passengers with similar health metrics but no history of past IMEs. In some examples, IME unit 206 may apply one or more machine learning (ML) models of ML module 208 to a dataset including the health metrics of the passenger to determine a passenger IME risk score for the passenger.

For each of the available voyages, IME unit 206 may aggregate the passenger IME risk scores of all booked passengers on the voyage to determine a voyage IME risk score. In some examples, computing system 102 may determine the voyage IME risk score by, for each respective passenger of the one or more passengers of the respective voyage, collecting the health metrics of the respective passengers, determining a passenger IME risk score based on the health metrics of the respective passenger, and determining the risk score of the respective voyage based on the passenger risk scores of the one or more passengers of the respective voyage. In some examples, the passenger risk score may correspond to a likelihood that the respective passenger will experience an IME during the voyage. IME unit 206 may apply one or more ML models of ML module 208 to a dataset containing the passenger IME risk scores to aggregate the passenger IME risk scores and determine the voyage IME risk score. In some examples, IME unit 206 may assign a classification label to the voyage IME risk score based on the score. The classification label may indicate the risk of IMEs on the voyage and/or the types of potential IMEs for the voyage. The classification labels may include, for example, “extremely low risk of IMEs”, “low risk of IMEs”, “moderate risk of IMEs”, “high risk of IMEs”, severe risk of IMEs”, and “critical risk of IMES”. For example, if IME unit 206 assigns a voyage IME risk score between 0 and 1000, IME unit 206 may assign a voyage with a voyage IME risk score of between 0 and 100 a classification label of “extremely low risk of IME” and assign a second voyage with a voyage IME risk score of between 750 and 900 a classification label of “severe risk of IME”. In some examples, IME unit 206 may receive the classification labels from user inputs (e.g., via user device 110). In other examples, IME unit 206 may determine the classification labels based on past IME occurrences and the corresponding past voyage IME risk scores.

In some examples in which the voyage has multiple stops to drop off and/or pick up passengers, the voyage may have a single voyage IME risk score for the entire voyage or may have a voyage IME risk score for each portion of the voyage between two of the stops on the voyage. The passenger IME risk scores, voyage IME risk scores, and classification labels for voyages may be stored in memory 104 of computing system 102 and/or transmitted to third-party computing system 114.

In some examples, IME unit 206 may sort the passengers into a plurality of IME risk categories (e.g., “extremely low risk”, “low risk”, “moderate risk”, etc.). IME unit 206 may store the IME risk categories in memory 104 and/or transmit the IME risk categories to third-party computing system 114.

In some examples, IME unit 206 may assign a voyage needs score for each of the available voyages based at least in part on the likelihood of an occurrence of an IME. IME unit 206 may determine the voyage needs score by applying one or more ML models of ML module 208 and/or statistical methods to a dataset containing the health metrics of the passengers to determine the voyage needs score. The voyage needs score may represent a level of need of the voyage to have a passenger with healthcare skills on board. IME unit 206 may increase or decrease the voyage needs score based on one or more factors including, but are not limited to, the average age of the passengers, whether any passengers had any recent medical procedures (e.g., surgeries), whether any passengers are traveling to receive medical treatment, duration of the voyage, whether any of the passengers have applicable healthcare skills, and whether any crew members have applicable healthcare skills. In some examples, IME unit 206 may assign a classification label to the voyage needs score (e.g., “low”, “medium”, “high”, or the like) based on the numerical value of the voyage needs score. In some examples, IME unit 206 may receive the classification labels to the voyage needs scores from user inputs (e.g., via user device 110). In other examples, IME unit 206 may determine the classification labels to the voyage needs scores based on past IME occurrences and the corresponding past voyage needs scores.

For each of the available voyages, booking system 116 may determine the applicability of the healthcare skills of user 112 to the potential IMEs. booking system 116 may apply one or more ML models of ML module 208 to the healthcare skills of user 112 and the health metrics of the passengers of each voyage to determine the applicability of the healthcare skills of user 112. In some examples, booking system 116 may determine the applicability of the healthcare skills of user 112 based on the determined potential IMEs for the voyage (e.g., the passenger IME risk scores, voyage IME risk score, and classification label for the voyage). booking system 116 may determine that the healthcare skills of user 112 are applicable to the potential IMEs of a voyage based on a determination that user 112 may be able treat the potential IMEs using the healthcare skills of user 112 and any on-board medical equipment without requiring diversion of the voyage. In some examples, processing circuitry 106 may also determine if the healthcare specialty of user 112 is related to the potential IMEs. For example, booking system 116 may determine that the healthcare specialty of optometry is related to a cardiac arrest and subsequently determine that the healthcare skills of user 112 who is an optometrist is not applicable.

In some examples, booking system 116 may assign an IME management ratings score to user 112 and determine the applicability of the healthcare skills of user 112 by comparing the IME management ratings score relative to the voyage needs scores of each of the available voyages, e.g., by using one or more ML models of ML module 208. In some examples, booking system 116 may assign a classification label to the IME management ratings score (e.g., “low”, “medium”, “high”, or the like) based on the numerical value of the voyage needs score. In some examples, booking system 116 may receive the classification labels from user inputs (e.g., via user device 110). In other examples, booking system 116 may determine the classification labels based on the healthcare skills of past individuals and the corresponding past IME management ratings scores.

Booking system 116 may determine that the healthcare skills of user 112 are applicable if the IME management ratings score matches or is in a similar classification as the voyage needs score. In some examples, booking system 116 may assign an IME management ratings score to user 112 based on one or more factors including, but not limited to, the type of healthcare training received by user 112, the number of years of medical practice by user 112, the experience of user 112 in handling past IMEs, the past outcomes of user 112 handling past IMEs, information from a medical rating system (e.g., Center for Medicare & Medicaid Services (CMS) Provider Rating), age of user 112, health status of user 112, whether user 112 is currently employed as a healthcare professional, usual travel routes of user 112, and the travel frequency of user 112 on a particular travel route.

Booking system 116 may determine, based on the applicability of the healthcare skills of user 112 and the likelihood of an IME, a user-specific incentive for each of the available voyages. The user-specific incentives may be configured to incentivize user 112 to choose one voyage over another. Booking system 116 may generate the user-specific incentives such that users 112 with healthcare skills are distributed amongst voyages to reduce a maximum number of diversions of voyages due to IMEs. Booking system 116 may select one or more target voyages from the plurality of voyages where the allocation of user 112 would reduce the largest number of diversions of voyages and select one or more user-specific incentives that would be the most likely to attract user 112 to choose one of the target voyages. Booking system 116 may determine the optimal distribution of users 112 amongst the flights by applying one or more ML models of ML module 208 to a dataset containing the applicable healthcare skills of users 112 and the likelihood of IMEs of the voyages. In some examples, booking system 116 may determine the optimal distributions of users 112 by applying one or more ML models of ML module 208 to a dataset containing the IME management ratings score of users 112 and voyage needs scores of the voyages).

Based on the optimal distributions of users 112, booking system 116 may determine the optimal user-specific incentives for each of the plurality of voyages using one or more ML models of ML module 208. The user-specific incentives may include monetary incentives, non-monetary incentives, and/or a combination of both. Monetary user-specific incentives may include, but are not limited to, discounts to voyages (either percentage-based or a flat reduction), shopping coupons, upgrades to premium seats (e.g., first-class, business-class), redeemable points (e.g., travel miles, flyer points, and the like), promotional tickets to events (e.g., sporting events, music concerts, movies), and the like. Non-monetary user-specific incentives may include, but are not limited to, additional luggage, seats with extra amenities (e.g., extra leg room), access to premium lounges, faster and/or assisted security clearance, continuing medical education (CME) credits, and the like.

Each user-specific incentive may be specific to each user 112 and a specific voyage of the plurality of voyages. For example, user 112 may have different user-specific incentives for voyages that are identical but have passengers with significantly different health metrics. In other examples, processing circuitry 106 may generate, for two users 112 with different applicable health skills, two different sets of user-specific incentives for the same voyage. Booking system 116 may generate the user-specific incentives based on user preferences and/or prior incentives accepted by user 112. In some examples, booking system 116 may store the user-specific incentives in memory 104 and/or transmit the user-specific incentives to third-party computing system 114.

UI unit 204 generate travel-booking user interface based on a user interface request from user 112. UI unit 204 may incorporate the user-specific incentives when generating the travel-booking interface user interface. For example, UI unit 204 may, apply a discount to the booking price of one or more voyages and/or provide an indication of non-monetary incentives for one or more voyages.

ML module 208 may store a plurality of ML models which may be retrieved and used by processing circuitry 106, booking system 116, UI unit 204, IME unit 206, or the like to determine one or more of the user-specific incentives, the applicability of the healthcare skills of user 112, the likelihood of occurrence of an IME on a voyage, and the like. ML models may include, but are not limited to, machine learning regression models, neural network models, convolutional networks or the like, e.g., as previously described in this disclosure. Each ML model may be trained to perform a different process. For example, ML module 208 may contain a first ML model configured to determine the applicability of the healthcare skills of user 112 and a second ML model configured to determine the user-specific incentives for a voyage. The first ML model and second ML model may be same type of ML model (e.g., both first ML model and second ML model may be neural network models. In other examples, the first ML model and the second ML model may be of different ML model types (e.g., first ML model may be a regression model and second ML model may be a neural network model).

The machine learning models of ML module 208 may include a regression model, a neural network model, a convolutional network model, a deep learning model, or the like. For example, a neural network model of ML module 208 may include an input layer, an output layer, and a plurality of hidden layers between the input layer and the output layer. In some examples, the plurality of hidden layers includes two hidden layers. In other examples, plurality of hidden layers includes other numbers of hidden layers. The neural network model may be configured to generate an output, e.g., a passenger IME risk score, a voyage IME risk score, a classification label, an IME management ratings score, a voyage needs score, or any other outputs of a ML model described in this disclosure.

An example neural network model may use rectifier linear unit (ReLU) functions in each of the hidden layers. The ReLU functions may be regularized, e.g., via a dropout functionality, to reduce overfitting. In some examples, value of the dropout functionality for a given hidden layer may be between about 0.3 and about 0.7. For example, the value of the dropout functionality may be 0.3 in a first layer, 0.5 in a second layer, and 0.7 in a third layer. In some examples, the output layer of the neural network model may be trained, e.g., by processing circuitry 106, ML module 208, or the like, using a replacement optimization algorithm (e.g., Adam Optimization Algorithm or the like) and/or a sigmoid function. In some examples, processing circuitry 108, ML module 208, or the like may train the dataset for a user-inputted number of epochs (e.g., about 275 epochs or more) to develop the ML model. In some examples, to evaluate the performance of a ML model, processing circuitry 106, ML module 208, or the like may apply a quadratic and/or a minimizing square loss function to the outputs of the ML model.

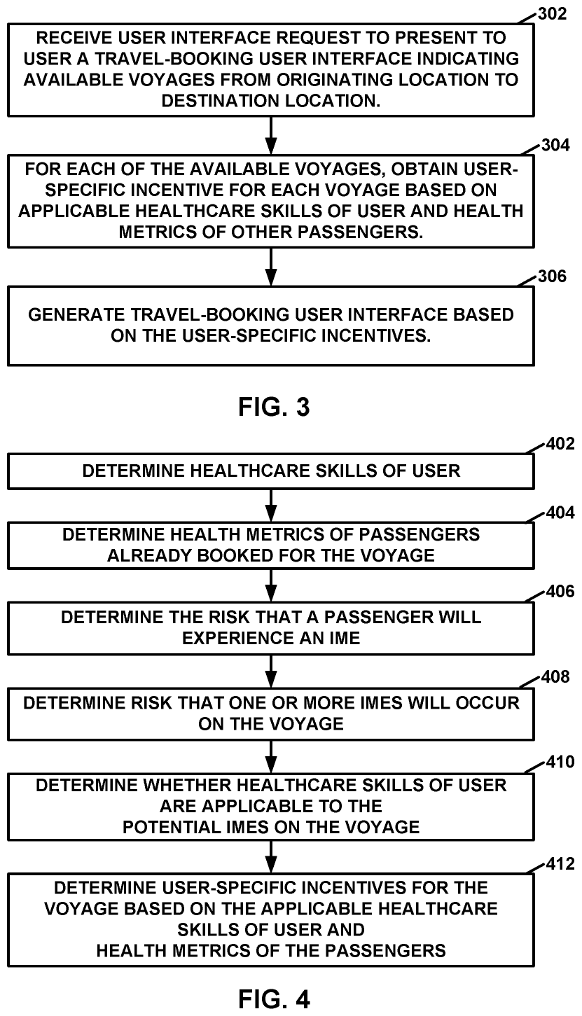

FIG. 3 is a flowchart illustrating an example process of generating a travel-booking user interface in response to a request from a user 112. A computing system (e.g., computing system 102) may receive a user interface request present to user 112 a travel-booking user interface that indicates one or more available voyages from an originating location to a destination location (302). The user interface request may include a plurality of parameters of a prospective voyage including the originating location and the destination location. In some examples, the parameters of the prospective voyage may further include, but are not limited to, one or more of the date of the voyage, the number of individuals in the part of user 112, special accommodations, the mode of transportation, and the like. User 112 may enter the user interface request to user device 110 or any other computing system and/or device configured to receive input from user 112. Computing system 102 may receive the user interface request from user device 110 through communications circuitry 108. In some examples, computing system 102 may receive data regarding the healthcare skills and/or health metrics of user 112 from user device 110 as a part of receiving the user interface request. In some examples, computing system 102 may store the data regarding the healthcare skills and/or health metrics of user 112 in memory 104 (e.g., in healthcare skills data unit 210 and passenger health data unit 212, respectively). Computing system 102 may, in response to receiving the user interface request, retrieve a list of available voyages from originating location to destination location.

In some examples, computing system 102 may, in response to receiving the user interface request, retrieve a list of available voyages from origination location to destination location that satisfy the plurality of parameters of the prospective voyage. Computing system 102 may retrieve the list of available voyages from memory 104, another computing system (e.g., third-party computing system 114), another computing device, the cloud computing environment, or the like. In some examples, computing system 102 may store information regarding each of the available voyages in the list of voyages in memory 104. The information regarding each of the available voyages may include information (e.g., healthcare skills) regarding the crew, health metrics of the passengers already booked on the voyage, healthcare skills of other passengers already booked on the voyage, costs of booking the voyage, type and/or status of the vehicle(s) used in the voyage, or the like.

Computing system 102 may, for each respective voyage of the available voyages, obtain a user-specific incentive for the respective voyage that is based at least in part on applicable healthcare skills of user 112 and health metrics of passengers that are already booked for the respective voyage (304). The applicable healthcare skills include healthcare skills that are applicable to an IME. For each of the available voyages, computing system 102 may obtain the user-specific incentive for the respective voyage by applying one or more machine learning (ML) models to a dataset including the applicable healthcare skills of user 112 and the likelihood that a passenger experiences an IME on the respective voyage. For example, booking system 116 of computing system 102 may, for each of the available voyages, apply a ML model (e.g., a regression model, a neural network model, or the like) to a dataset including the applicable healthcare skills of user 112 and the likelihood a passenger will experience an IME to obtain the user-specific incentive for the respective voyage. In some examples, computing system 102 may, for each respective voyage, determine a passenger IME risk score for each passenger and/or a voyage IME risk score for the entire voyage based on the health metrics of the passengers already booked for the respective voyage. Computing system 102 may determine the passenger IME risk score and/or voyage IME risk score in accordance with the example process previously discussed in the disclosure. In some examples, computing system 102 may, for each respective voyage of the available voyages, determine a voyage needs score, an IME management ratings score for user 112, and apply a ML model to a dataset including the voyage needs scores and the IME management ratings score to determine the user-specific incentive, e.g., in accordance with the example process previously discussed in the disclosure. Computing system 102 may determine the user-specific incentives by using processing circuitry 106 to execute instructions from booking system 116 in memory 104 (e.g., from UI unit 204, IME unit 206, or the like) to generate the user-specific incentives for each voyage of the available voyages. The user-specific incentives may include one or more monetary incentives, one or more non-monetary incentives, or a combination of one or more monetary incentives and one or more non-monetary incentives.

Computing system 102 may generate a travel-booking user interface based on the user-specific incentives (306). In some examples, the travel-booking user interface may display the list of available voyages and the user-specific incentives for each respective voyage of the available voyages. Computing device 102 may generate the travel-booking user interface by using processing circuitry 106 to execute instructions retrieved from memory 104 (e.g., from UI unit 204 of booking system 116). Computing device 102 may transmit the travel-booking user interface to user device 110 through communications circuitry 108. In some examples, computing device 102 may transmit to user device 110 instructions to display travel-booking user interface on user device 110, e.g., on a user interface (e.g., a display screen) of user device 110.

FIG. 4 is a flowchart illustrating an example process of determining user-specific incentives for a voyage. The example process of FIG. 4 is described with respect to a single voyage, but a computing system (e.g., computing system 102) may apply the example process to each voyage of a list of available voyages. Computing system 102 may determine healthcare skills of a user (e.g., user 112) (402). In some examples, user 112 may input the healthcare skills information as a part of requesting computing system 102 to generate a travel-booking user interface, e.g., via an option to search for voyages as a healthcare professional. In other examples, user 112 may input the healthcare skills information at a time prior to requesting computing system 102 to generate a travel-booking user interface, e.g., as a part of a prior request to computing system 102, as a part of a travel account held by user 112 (e.g., a frequent flyer account), or the like. In some examples, user 112 may input the healthcare skills into computing system 102 through user device 110. User 112 may input the healthcare skills into computing system 102 by completing a survey, by submitting proof of education (e.g., diplomas, certifications, licenses, or the like), or by filing out a questionnaire. In some examples, user 112 may be required to submit the contact information of individuals who may be able to verify the healthcare skills of user 112. Computing system 102 may store the healthcare skills of user 112 in healthcare skills data unit 210 of memory 104. In some examples, computing system 102 may transmit the healthcare skills of user 112 for storage in a separate computing system, computing device, cloud computing environment, or the like.

Computing system 102 may determine the health metrics of passengers already booked for the voyage (404). Computing system 102 may determine the health metrics of the passengers already booked for the voyage by determining the identities of passengers already booked for the voyage and retrieving, for each of the passengers, information corresponding to the health metrics of the passenger. In some examples, computing system 102 may retrieve the identities of passengers and/or the information corresponding to the health metrics of the passengers from memory 104 (e.g., passenger health data unit 212), third-party computing system 114, another computing system, another computing device, a cloud computing environment, or the like. In some examples, computing system 102 may update the information corresponding to the health metrics of one or more of the passengers upon receiving updated health information for the one or more passengers.

Computing system 102 may determine the risk that a passenger on the voyage will experience an in-voyage medical emergency (IME) (406). Computing system 102 may determine the risk that the passenger will experience the IME based on the information corresponding to the health metrics of the passenger. The information corresponding to the health metrics of the passenger may be stored in or communicated to computing system 102. Computing system 102 may determine the risk that the passenger will experience the IME based on one or more of current illnesses and/or injuries, past illnesses and/or injuries, family history of illnesses, current medications, surgical history, vaccination history, past IMEs, recent biometric screening results, and the like. In some examples, computing system 102 may determine the risk by determining the likelihood of, the type of, and/or the severity of the potential IME the passenger may experience. In some examples, computing system 102 may determine the risk that a passenger on the voyage will experience an IME by determining a passenger IME risk score, e.g., in accordance with the example processes discussed herein. In some examples, computing system 102 may update the risk that the passenger will experience an IME based on updated information corresponding to the health metrics of the passenger received by computing system 102.

In some examples, as illustrated in FIG. 4, computing system 102 may determine the risk that one or more in-voyage medical emergencies (IMEs) will occur on the voyage (408). The risk that one or more IMEs may represent the likelihood that one or more potential IMEs will occur during the voyage. In some examples, computing system 102 may determine a risk score (e.g., a voyage IME risk score) for the voyage that corresponds to a risk that one or more of the passengers of the voyage will experience an IME during the voyage, e.g., in accordance with the example process previously discussed herein. Computing system 102 may update the risk that one or more IMEs will occur on the voyage upon receiving changes in the health metrics of the passengers and/or the number and/or identities of the passengers on the voyage.

Computing system 102 may determine whether healthcare skills of user 112 are applicable to the potential IMEs on the voyage (410). Computing system 102 may determine that the healthcare skills of user 112 are applicable to the potential IMEs on the voyage by determining that, based on the healthcare skills of user 112, user 112 may be able to treat the potential IMEs using the healthcare skills and any on-board medical equipment without requiring the voyage to divert. Computing system 102 may determine the applicability of the healthcare skills of user 112 using a ML model. In some examples, computing system 102 may determine the applicability of the healthcare skills of user 112 by determining an IME management ratings score of user 112, e.g., in accordance with the example processes previously discussed herein. In some examples, computing system 102 may determine the applicability of the healthcare skills of user 112 by applying a ML model to a dataset including IME management ratings score of user 112 and a voyage needs score of the voyage.

Computing system 102 may determine user-specific incentives for the voyage based on the applicable healthcare skills of user 112 and the health metrics of the passengers (412). In some examples, computing system 102 may determine the user-specific incentives for the voyage based on the applicable healthcare skills of user 112 and the risk score for the voyage. The user-specific incentives may include monetary and/or non-monetary incentives and may be configured to incentivize user 112 to book a seat on the voyage. In some examples, computing system 102 may determine one or more separate user-specific incentives for the voyage. In some examples, computing system 102 may provide user 112 an option, e.g., on the travel-booking user interface, to switch between two or more user-specific incentives for the voyage. In some examples, computing system 102 may determine the user-specific incentives by applying one or more ML models to a dataset containing the applicable healthcare skills of user 112 and the risk that one or more IMEs will occur on the voyage. In some examples, computing system 102 may determine the user-specific incentives, e.g., in accordance with the example processes previously discussed herein.

Computing system 102 may update the user-specific incentives at a later time. In some examples, computing system 102 may update the user-specific incentives as the travel date of the respective voyage becomes closer. In some examples, if user 112 does not book a seat on one of the voyages despite the user-specific incentives, computing system 102 may update the user-specific incentives to further incentivize user 112 to book a seat on the voyage.

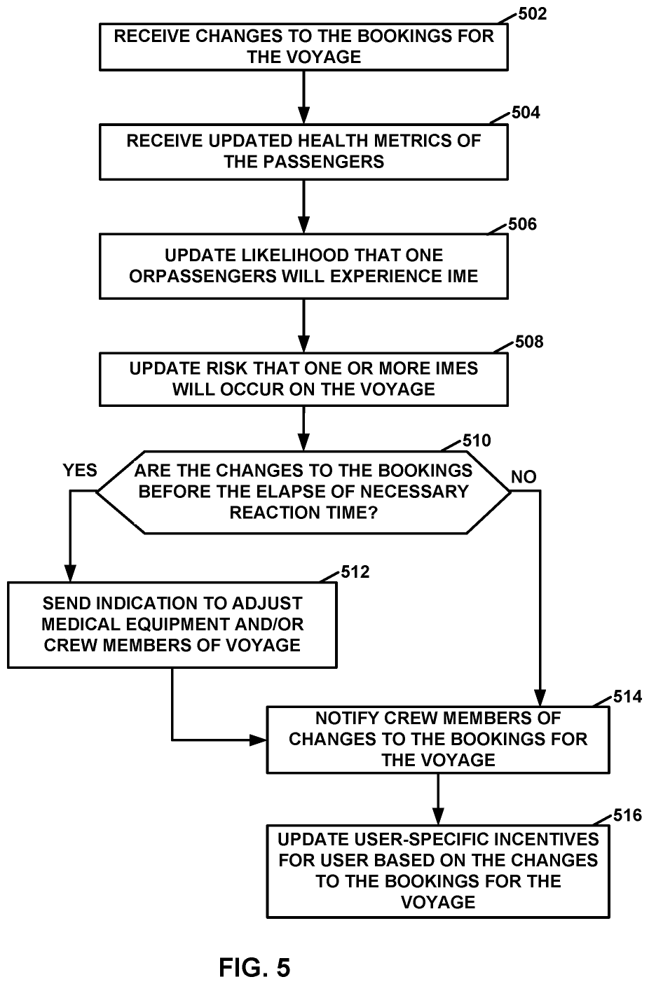

FIG. 5 is a flowchart illustrating an example process of updating user-specific incentives for a voyage in response to changes in the bookings for the voyage. In some examples, the example process of FIG. 5 may be performed after an example process of determining user-specific incentives for a voyage, e.g., as illustrated in the example process of FIG. 4. Computing system 102 may receive changes to the bookings for the voyage (502). In some examples, the changes to the bookings for the voyage may include new passengers on the voyage. In some examples, the changes to the bookings for the voyage may include changes in the identifies of the passengers already booked on the voyage. In some examples, the changes to the bookings for the voyage may include computing system 102 receiving the health metrics of a passenger who is booked for the voyage but did not provide the health metrics at the time of the booking. In some examples, computing system 102 may receive changes to the health metrics of the passengers in addition to or instead of the changes to the bookings for the voyage. Computing system 102 may receive the changes to the bookings for the voyage via an indication from one or more computing devices, computing systems, and/or cloud computing environment.

Computing system 102 may receive updated health metrics of the passengers (504). In some examples computing system 102 may, in response to an indication that there are one or more changes to the bookings for the voyage, request the updated health metrics of the passengers from one or more computing devices, computing systems, and/or cloud computing environment. The updated health metrics may include updated information and/or new information regarding one or more of current illnesses and/or injuries, past illnesses and/or injuries, family history of illnesses, current medications, surgical history, vaccination history, past IMEs, recent biometric screening results, and the like that is different from or missing from the health metrics of the passengers currently stored in computing system 102, e.g., in passenger health data unit 214. Computing system 102 may receive the updated health metrics of the passengers from one or more computing devices, computing systems, and/or cloud computing environment.

Computing system 102 may update the likelihood that the one or more of the passengers will experience an IME (506). In some examples, computing system 102 may, as part of updating the likelihood that the one or more of the passengers will experience an IME, update and/or calculate the passenger IME risk score of each of the one or more passengers on the voyage. Computing system 102 may update the passenger IME risk score of each of the one or more passengers on the voyage in accordance with one or more example processes discussed herein.

Computing system 102 may update the risk that one or more IMEs will occur on the voyage (508). In some examples, computing system 102 may update the risk by updating the voyage IME risk score for the voyage. In some examples, computing system 102 may also update the voyage needs score for the voyage. Computing system 102 may update the voyage IME risk score and/or the voyage needs score of each of the one or more passengers on the voyage in accordance with one or more example processes discussed herein,

Computing system 102 may determine if the changes to the bookings for the voyage occurs before the elapse of a necessary reaction time (510). The necessary reaction time may be an amount of time required for crew members and/or other staff members of a voyage (e.g., airport staff, train station staff) to prepare for a given type of IME (e.g., cardiac arrests). In some examples, the crew members and/or other staff members of a voyage may prepare for the given type of IME by assigning crew members with applicable healthcare skills to address the given type of IME, store medical equipment configured to address the given type of IME in one or more vehicles for the voyage, or the like.

If computing system 102 determines that the changes to the bookings are before the elapse of the necessary reaction time (“YES” branch of 510), computing system 102 may send an indication to adjust the medical equipment and/or crew members of the voyage (512). Computing system 102 may send the indication to one or more computing devices and/or computing systems of one or more of the owners and/or operators of the voyage, staff members of a transportation station at the originating location (e.g., train station, bus station, harbor, airport, or the like), or the like. In some examples, the owners and/or operators of the voyage, staff members of the transportation station at the originating location, and/or the crew members of the voyage will, in response to the indication from computing system 102, adjust the medical equipment and/or crew members of the voyage. Adjusting the medical equipment and/or crew members of the voyage may include adding medical equipment and/or crew members configured to address the given type of IME and/or removing medical equipment and/or crew members not configured to address the given type of IME.

If computing system 102 determines that the changes to the bookings are after the elapse of the necessary reaction time (“NO” branch of 510), computing system 102 may notify the crew members of the voyage of changes to the bookings for the voyage (514). Computing system 102 may not send an indication to adjust the medical equipment and/or crew members of the voyage. In some examples, computing system 102 may not send the indication since there is insufficient time to adjust the medical equipment and/or crew members of the voyage.

Computing system 102 may notify crew members of the voyage of changes to the bookings of the voyage (514). Computing system 102 may, as part of notifying the crew members of the changes to the bookings, notify the crew members of the changes to the types, severity, and/or likelihood of occurrence of one or more IMEs.

Computing system 102 may update the user-specific incentives for user 112 based on the changes to the bookings for the voyage (516). Computing system 102 may update the applicability of healthcare skills of user 112 based on the changes to the bookings. In some examples, computing system 102 may determine an updated voyage needs score and/or an updated IME management ratings score based on the changes to the bookings for the voyage. Computing system 102 may determine the updated applicability of the healthcare skills of user 112 based on the updated IME management ratings score and the updated voyage needs score. Computing system 102 may update the user-specific incentives by applying one or more ML models to a dataset containing the updated applicable healthcare skills of user 112 and the updated risk that one or more IMEs will occur on the voyage. For example, computing system 102 may apply a regression ML model, a neural network model, a convolutional network model, or the like to the dataset including the updated IME management ratings score and the updated voyage needs score to generate an updated user-specific incentive for the voyage. In some examples, ML module 208 may train the ML model using a dataset including past IME management ratings scores for previous individuals on past voyages, the corresponding past voyage needs scores, and the corresponding past user-specific incentives for the previous individuals.

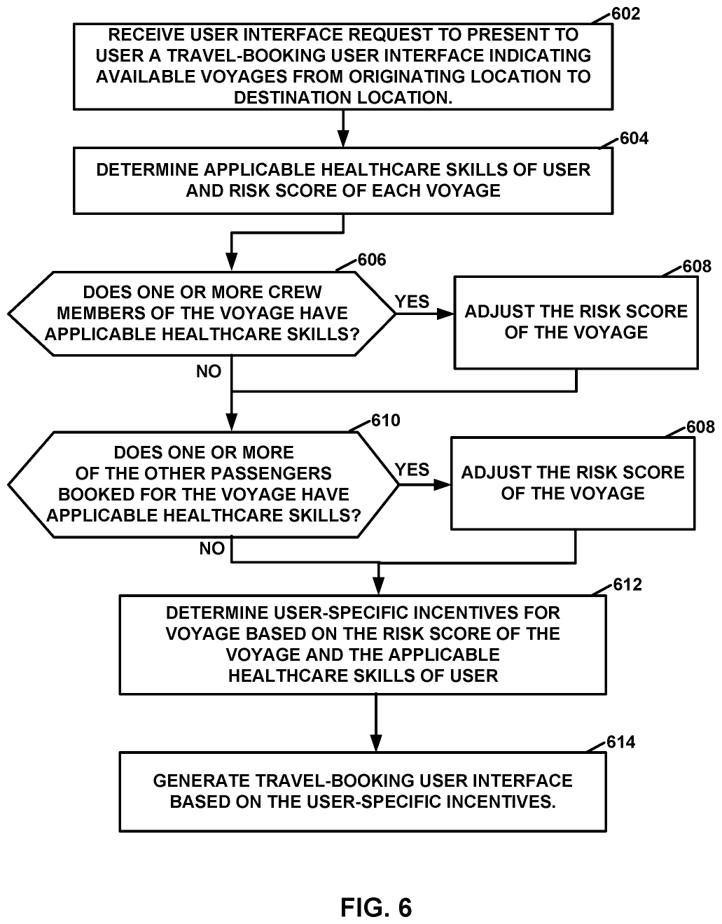

FIG. 6 is a flowchart illustrating an example process of determining user-specific incentives for a voyage based on the applicable healthcare skills of other persons on the voyage. In some examples, as illustrated in FIG. 6, computing system 102 may obtain the user-specific incentive for the voyage based at least in part on the applicable healthcare skills of user 112, the health metrics of the passengers that are already booked for the voyage, and the applicable healthcare skills of one or more passengers that are already booked for the voyage. In some examples, as illustrated in FIG. 6, computing system 102 may obtain the user-specific incentive for the voyage based at least in part on applicable healthcare skills of user 112, the health metrics of the passengers that are already booked for the voyage, and the applicable healthcare skills of one or more crew members of the voyage.

In the example of FIG. 6, computing system 102 may receive a user interface request to present to user 112 a travel-booking user interface indicating available voyages from originating location to destination location (602). Computing system 102 may determine the applicable healthcare skills of user 112 and the risk score of each voyage (604), e.g., in accordance with one or more example processes discussed herein.

For each respective voyage, computing system 102 may determine if any other individuals (e.g., crew members and/or other passengers) on the voyage have applicable healthcare skills. If computing system 102 determines that one or more crew members of the voyage have applicable healthcare skills (“YES” branch of 606), computing system 102 may adjust the risk score of the voyage (608). The risk score of the voyage may include the voyage needs score for the respective voyage. Computing system 102 may reduce the voyage needs score based on the determination that one or more crew members of the voyage have applicable healthcare skills (“YES” branch of 606). Computing system 102 may determine a reduction in the voyage needs score based on the number of crew members with applicable healthcare skills and/or the quality of the applicable healthcare skills of the crew members. In some examples, computing system 102 may determine a crew IME management ratings score for each crew member with applicable healthcare skills. In some examples, computing system 102 may determine the adjustment to the voyage needs score by applying a ML model (e.g., a regression model, a neural network model, a convolution network model, or the like) to a dataset including the risk that one or more passengers will experience an IME (e.g., passenger IME risk scores, voyage IME risk score, or the like) and the applicable healthcare skills of the crew members (e.g., the crew IME management ratings scores of the crew members). ML module 208 may train the ML model using a dataset including past voyage needs scores for previous voyages, the corresponding risk of IME (e.g., past passenger IME risk scores, past voyage IME risk scores, or the like) for the previous voyages, and the applicable healthcare skills of the crew members for the previous voyages. If computing system 102 determines that none of the crew members of the voyage have applicable healthcare skills (“NO” branch of 606), computing system 102 may not adjust the risk score of the voyage.

If computing system 102 determines that one or more of the other passengers booked for the voyage have applicable healthcare skills (“YES” branch of 610), computing system 102 may adjust the risk score of the voyage (608), e.g., by adjusting the voyage needs score of the voyage. If computing system 102 determines that none of the other passengers booked for the voyage have applicable healthcare skills (“NO” branch of 610), computing system 102 may not adjust the risk score of the voyage.

Computing system 102 may determine the user-specific incentives for the voyage based on the risk score of the voyage and the applicable healthcare skills of user 112 (612). The risk score of the voyage may include the adjusted voyage needs score for the voyage. Computing system 102 may determine the user-specific incentives for the voyage in accordance with one or more example processes discussed herein. In some examples, computing system 102 may determine the user-specific incentives for the voyage by applying a ML model, e.g., as previously described in this disclosure, to a dataset including the IME management ratings score of user 112 and the adjusted voyage needs score for the voyage. ML module 208 may train the ML model using a dataset including past IME management ratings scores for past individuals on previous voyages, the past voyage needs scores for the previous voyages, and the user-specific incentives for the past individuals.

Computing system 102 may generate a travel-booking user interface based on the user-specific incentives (614). Computing system 102 may generate the travel-booking user interface in accordance with one or more example processes discussed herein.

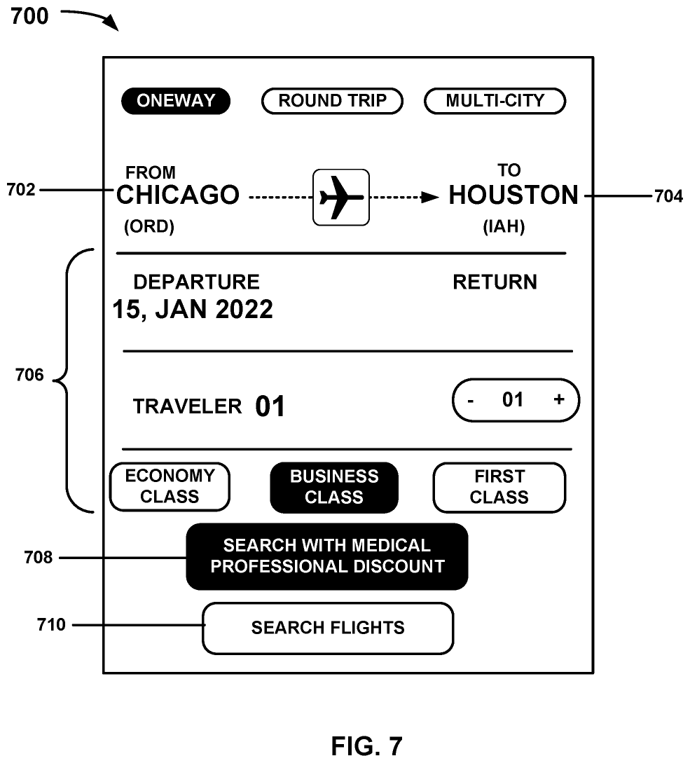

FIG. 7 is an example user interface (UI) 700 displayed on a user device (e.g., user device 110) to receive a user interface request from a user (e.g., user 112) to present a travel-booking user interface. While UI 700 is illustrated and described with respect to air travel, a similar user interface may be displayed for voyages involving other modes of transportation (e.g., via bus, via train, via ship, or the like). UI 700 may indicate selections from user 112 regarding input parameters of a search for voyages including originating location 702, destination location 704, voyage parameters 706 (e.g., number of travelers, date of departure, date of return, class, and the like). UI 700 may provide an option for user 112 to perform a standard search 710 or a search based on the healthcare skills of user 112 (“Search with Medical Professional Discount”, also referred to as “Healthcare search 708”).

In some examples, computing system 102 may select a number of available voyages for user 112 based on the input parameters from user 112. In some examples, computing system 102 may select voyages that satisfy all of the input parameters from user 112 for the number of available voyages. In other examples, computing system 102 may select voyages that satisfy at least some of the input parameters from user 112 (e.g., originating location 602, destination location 604, and date of departure only) for the number of available voyages. In some examples, after computing system 102 has selected the number of available voyages, user 112 may further modify one or more of the input parameters and/or add new input parameters through user device 110 and computing system 102 may update the number of available voyages accordingly.

If computing system 102 receives user input (E.g., from user 112 via user device 110) to perform a standard search 710, computing system 102 may generate a travel-booking user interface without accounting for any healthcare skills of user 112. Computing system 102 may generate a travel-booking user interface that does not include any user-specific incentives for any of the voyages.

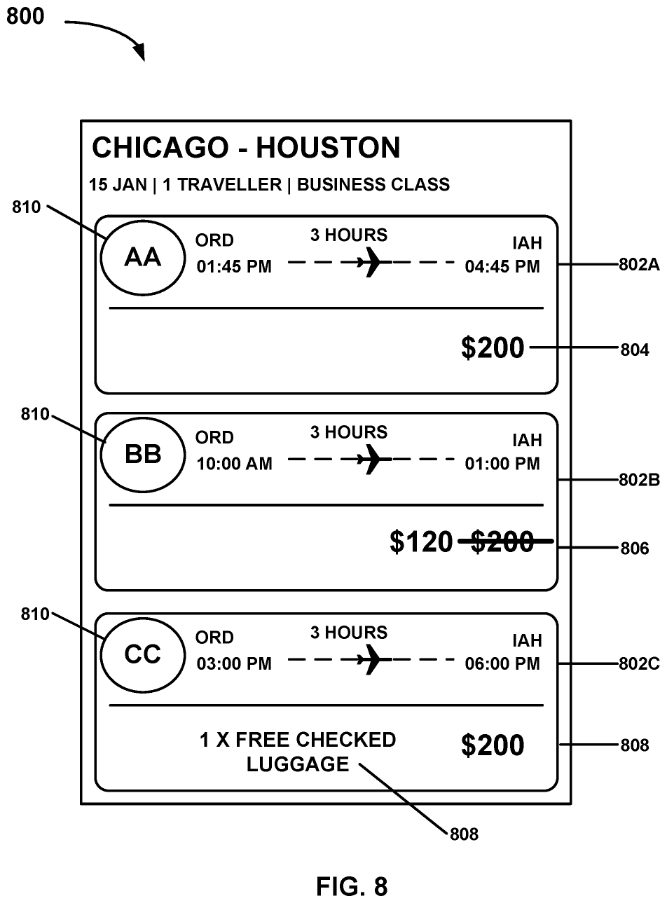

If computing system 102 receives user input (E.g., from user 112 via user device 110) to perform a healthcare search 708, computing system 102 may generate a travel-booking user interface that includes the user-specific incentives for one or more of the available voyages. An example travel-booking user interface including the user-specific incentives is illustrated in FIG. 8.

FIG. 8 is an example travel-booking user interface (UI) 800 generated by a computing system 102 based on a plurality of user-specific incentives corresponding to a plurality of voyages. UI 800 may display one or more available voyages 802A-C (collectively referred to as “voyages 802”) and voyages details for each of voyages 802. The voyage details for each of voyages 802 may include a price 612, any amenities, and any user-specific incentives (e.g., monetary incentives 614 and/or non-monetary incentives 616).

For each of voyages 802, UI 800 may illustrate, as part of the voyage details, the originating location, the destination location, the number of travelers, the class of the seat, the duration of the voyage, the time of departure, and time of arrival, the operator of the voyage (herein referred to as “operator 810”), or the like. For some of the available voyages, such as with voyage 802A, computing system 102 may not generate a user-specific incentive for user 112. As such, computing system 102 may not display any user-specific incentives for voyage 802A on UI 800. In some examples, such as with voyage 802B, computing system 102 may determine that a monetary user-specific incentive 806, such as a booking price discount as illustrated in FIG. 8, is appropriate for voyage 802B and may display monetary user-specific incentive 806 in the voyage details of voyage 802B on UI 800. In some examples, such as with voyage 802C, computing system 102 may determine that a non-monetary user specific incentive 808, such as free checked luggage as illustrated in FIG. 8, is appropriate for voyage 802C and may display non-monetary user specific incentive 808 in the voyage details of voyage 802C on UI 800.

In some examples, monetary user-specific incentive 806 may include, but are not limited to, booking price discounts (either percentage-based or a flat reduction), shopping coupons, upgrades to premium seats (e.g., first-class, business-class), redeemable points (e.g., travel miles, flyer points, and the like), promotional tickets to events (e.g., sporting events, music concerts, movies), or the like. In some examples, non-monetary incentives 808 may include, but are not limited to, additional luggage, seats with extra amenities (e.g., extra leg room), access to premium lounges, faster and/or assisted security clearance, continuing medical education (CME) credits, or the like. In some examples, UI 800 may provide user 112 with an option to switch between two or more user-specific incentives for one or more of voyages 802.

The following is a non-limiting list of examples that may be in accordance with one or more techniques of this disclosure.

Example 1: a method for generation of travel-booking user interfaces, the method comprising: receiving, by a computing system, a user interface request to present to a user a travel-booking user interface that indicates one or more voyages from an originating location to a destination location; for each respective voyage of the one or more available voyages, determining, by the computing system, a user-specific incentive for the respective voyage that is based at least in part on applicable healthcare skills of the user and health metrics of passengers that are already booked for the respective voyage, wherein the applicable healthcare skills include healthcare skills that are applicable to an in-voyage medical emergency; and based on the user interface request, generating, by the computing system, the travel-booking user interface based on the determined user-specific incentive.

Example 2: the method of example 1, wherein: the method further comprises determining, by the computing system, for each respective voyage of the one or more available voyages, a risk score for the respective voyage that corresponds to a risk that one or more of the passengers of the respective voyage will experience a medical emergency during the respective voyage, and wherein determining the user-specific incentive for the respective voyage comprises determining, by the computing system, the user-specific incentive for the respective voyage based on the applicable healthcare skills of the user and the risk score for the respective voyage.

Example 3: the method of example 2, wherein determining the risk score comprises: for each respective passenger of the one or more passengers of the respective voyage: collecting, by the computing system, one or more health metrics of the respective passenger; and determining, by the computing system, a passenger risk score of the respective passenger based on the health metrics of the respective passenger, wherein the passenger risk score corresponds to a likelihood that the respective passenger will experience a medical emergency during the respective voyage; and determining, by the computing system, the risk score of the respective voyage based on the passenger risk scores of the one or more passengers of the respective voyage.

Example 4: the method of any of examples 1-3, wherein determining the user-specific incentive for the respective voyage comprises applying a machine learning technique to a dataset comprising the applicable healthcare skills of the user and the health metrics of the passengers that are already booked for the respective voyage to generate the user-specific incentive for the respective voyage of the one or more voyages.

Example 5: the method of example 4, wherein the machine learning technique comprises a regression algorithm.

Example 6: the method of any of examples 1-5, further comprising: prior to the computing system receiving the user interface request, obtaining, by the computing system, data indicating the healthcare skills of the user; storing, by the computing system, the data indicating the healthcare skills of the user in a memory; and obtaining, by the computing system, the data indicating the healthcare skills of the user from the memory.

Example 7: the method of any of examples 1-6, wherein determining the user-specific incentive for the respective voyage comprises determining the user-specific incentive for the respective voyage based at least in part on the applicable healthcare skills of the user, the health metrics of the passengers that are already booked for the voyage, and the applicable healthcare skills of one or more of the passengers already booked for the respective voyage.

Example 8: the method of any of examples 1-7, wherein determining the user-specific incentive for the respective voyage comprises determining the user-specific incentive for the respective voyage based at least in part on the applicable healthcare skills of the user, the health metrics of the passengers that are already booked for the voyage, and the applicable healthcare skills of one or more crew members of the respective voyage.

Example 9: the method of any of examples 1-8, further comprising: prior to the computing system receiving the user interface request, obtaining, by the computing system for each respective voyage, data corresponding to the health metrics of the passengers by: obtaining data corresponding to the health metrics from one or more computing devices, wherein each computing device corresponds to one or more of the passengers; and storing, by the computing system, the data corresponding to the health metrics of the passengers in a memory; and obtaining, by the computing system, the data indicating the health metrics of the passengers from the memory.

Example 10: the method of any of examples 1-9, further comprising transmitting, by the computing system, at least one of the healthcare skills of the user, the health metrics of the passengers for each respective voyage of the one or more available voyages, and the user-specific incentive for the respective voyage to a computing device corresponding to a third party.

Example 11: a computing system comprising: memory; and processing circuitry configured to: receive a user interface request to present to a user a travel-booking user interface that indicates one or more available voyages from an originating location to a destination location; for each respective voyage of the one or more available voyages, determine a user-specific incentive for the respective voyage that is based at least in part on applicable healthcare skills of the user and health metrics of passengers that are already booked for the respective voyage, wherein the applicable healthcare skills include healthcare skills that are applicable to an in-voyage medical emergency, and wherein the applicable healthcare skills of the user and the health metrics of the passengers are stored in the memory; and based on the user interface request, generate the travel-booking user interface based on the determined user-specific incentive.

Example 12: the computing system of example 11, wherein the processing circuitry is further configured, for each respective voyage of the one or more available voyages, to: determine a risk score for the respective voyage that corresponds to a risk that one or more of the passengers of the respective voyage will experience a medical emergency during the respective voyage; and determine the user-specific incentive for the respective voyage based on the applicable healthcare skills of the user and the risk score for the respective voyage.

Example 13: the computing system of example 12, wherein to determine the risk score, the processing circuitry is configured to: for each respective passenger of the one or more passengers of the respective voyage: collect one or more health metrics of the respective passenger; and determine a passenger risk score of the respective passenger based on the health metrics of the respective passenger, wherein the passenger risk score corresponds to a likelihood that the respective passenger will experience a medical emergency during the respective voyage; and determine the risk score of the respective voyage based on the passenger risk scores of the one or more passengers of the respective voyage.

Example 14: The computing system of any of examples 11-13, wherein to determine the user-specific incentive for the respective voyage, the processing circuitry is configured to apply a machine learning technique to a dataset comprising applicable healthcare skills of the user and the health metrics of the passengers that are already booked for the respective voyage to generate the user-specific incentive for the respective voyage of the one or more voyages.

Example 15: The computing system of any of examples 11-14, wherein to determine the user-specific incentive for the respective voyage, the processing circuitry is further configured to determine the user-specific incentive for the respective voyage based at least in part on the applicable healthcare skills of the user, the health metrics of the passengers that are already booked for the voyage, and the applicable healthcare skills of one or more of the passengers already booked for the respective voyage.

Example 16: The computing system of any of examples 11-15, wherein to determine the user-specific incentive for the respective voyage, the processing circuitry is further configured to determine the user-specific incentive for the respective voyage based at least in part on the applicable healthcare skills of the user, the health metrics of the passengers that are already booked for the voyage, and the applicable healthcare skills of one or more crew members of the respective voyage.

Example 17: The computing system of any of examples 11-16, wherein the processing circuitry is further configured to: prior to receiving the user interface request, obtain data indicating the healthcare skills of the user from the user; store the data indicating the healthcare skills of the user in the memory; and obtain the data indicating the healthcare skills of the user from the memory.

Example 18: A non-transitory computer readable medium comprising instructions that, when executed, cause processing circuitry of a computing system to: receive a user interface request to present to a user a travel-booking user interface that indicates one or more available voyages from an originating location to a destination location; for each respective voyage of the one or more available voyages, determine a user-specific incentive for the respective voyage that is based at least in part on applicable healthcare skills of the user and health metrics of passengers that are already booked for the respective voyage, wherein the applicable healthcare skills include healthcare skills that are applicable to an in-voyage medical emergency; and based on the user interface request, generate the travel-booking user interface based on the determined user-specific incentive.

Example 19: The non-transitory computer readable medium of example 18, further comprising instructions that cause the processing circuitry to, for each respective voyage of the one or more available voyages: determine a risk score for the respective voyage that corresponds to a risk that one or more passengers of the respective voyage will experience a medical emergency during the respective voyage; and determine the user-specific incentive of the respective voyage by determining the user-specific incentive based on the available healthcare skills of the user and the risk score for the respective voyage.

Example 20: The non-transitory computer readable medium of example 19, wherein to determine the risk score, the instructions cause the processing circuitry to: for each respective passenger of the one or more passengers of the respective voyage: collect one or more health metrics of the respective passenger; and determine a passenger risk score for the respective passenger based on the health metrics of the respective passenger, wherein the passenger risk score for the respective passenger corresponds to a likelihood that the respective passenger will experience a medical emergency during the respective voyage; and determine the risk score for the respective voyage based on the passenger risk scores for the one or more passengers.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, “device” or “devices” (e.g., user device 110) may include a plurality of hardware appliances configured to receive telecommunications from one or more other parties. The hardware appliances include, but are not limited to, cellphones, smartphones, tablets, laptops, personal computers, or smartwatches. In other examples “device” or “devices” may include the use of a browser to communicate with one or more other devices.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) a tangible computer-readable storage medium which is non-transitory or (2) a communication medium such as a signal or carrier wave. Data storage media may be any available media that can be accessed by one or more computers or one or more processing circuits to retrieve instructions, code, and/or data structures for implementation of the techniques describes in this disclosure. A computer program product may include a computer-readable medium.

By way of example, and not limitation, such computer-readable storage media can comprise RAM, ROM, EEPROM, CD-ROM or other optical disk storage, magnetic disk storage or other magnetic storage devices, flash memory, cache memory, or any other medium that can be used to store desired program code in the form of instructions or data structures that can be accessed by a computer. Also, any connection is properly termed a computer-readable medium. For example, is instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Combinations of the above should also be included within the scope of computer-readable media.

Functionality described in this disclosure may be performed by fixed function and/or programming processing circuitry. For instance, instructions may be executed by fixed function and/or programmable processing circuitry. Such processing circuitry may include one or more processors, such as one or more digital signal processors (DSPs), general purpose microprocessors, application specific integrated circuits (ASIC s), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some respects, the functionality described herein may be provided within dedicated hardware and/or software modules. Also, the techniques could be fully implemented in one or more circuits or logic elements. Processing circuits may be coupled to other components in various ways. For example, a processing circuit may be coupled to other components via an internal device interconnect, a wired or wireless network connection, or another communication medium.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

1. A method for generation of a travel-booking user interface, the method comprising:
receiving, by a computing system and from a user device associated with a user, a user interface request including one or more parameters of a prospective voyage;
accessing, by the computing system, memory that stores healthcare skills data associated with the user and health metric data of one or more passengers associated with the prospective voyage;
applying, by the computing system and to the health metric data, a machine learning (ML) model to generate a risk score indicative of a likelihood that a medical emergency will occur during the prospective voyage, wherein the ML model is trained using one or more of in-voyage medical event management ratings from past voyages of particular users, need scores of the past voyages, or user-specific incentives of the past voyages;
determining, by the computing system and based on the risk score and the healthcare skills data associated with the user, a user-specific incentive for the prospective voyage; and
generating, by the computing system, the travel-booking user interface for displaying the user-specific incentive.

2. (canceled)

3. The method of claim 1, wherein applying the ML model to generate a risk score comprises:
for each respective passenger of the one or more passengers associated with the prospective voyage:
collecting, by the computing system, one or more health metrics of the respective passenger; and
determining, by the computing system, a passenger risk score of the respective passenger based on the health metrics of the respective passenger, wherein the passenger risk score corresponds to a likelihood that the respective passenger will experience a medical emergency during the prospective voyage; and
determining, by the computing system, the risk score of the prospective voyage based on the passenger risk scores of the one or more passengers associated with the prospective voyage.

4. (canceled)

5. The method of claim 1, wherein the ML model comprises a regression algorithm.

6. The method of claim 1, further comprising:
prior to the computing system receiving the user interface request, obtaining, by the computing system, the healthcare skills data associated with the user;
storing, by the computing system, the healthcare skills data associated with the user in a memory; and
obtaining, by the computing system, the healthcare skills data associated with the user from the memory.

7. The method of claim 1, wherein determining the user-specific incentive for the prospective voyage comprises determining the user-specific incentive for the prospective voyage based at least in part on the healthcare skills data associated with the user, the health metric data of the one or more passengers associated with the prospective voyage, and applicable healthcare skills of the one or more passengers associated with the prospective voyage.

8. The method of claim 1, wherein determining the user-specific incentive for the prospective voyage comprises determining the user-specific incentive for the prospective voyage based at least in part on the healthcare skills data associated with the user, the health metric data of the one or more passengers associated with the prospective voyage, and applicable healthcare skills of one or more crew members of the prospective voyage.

9. The method of claim 1, further comprising:
prior to the computing system receiving the user interface request, obtaining, by the computing system, the health metric data by:
obtaining health metric data from one or more computing devices, wherein each of the computing devices corresponds to one or more of the one or more passengers associated with the prospective voyage; and
storing, by the computing system, the health metric data in a memory; and
obtaining, by the computing system, the health metric data of from the memory.

10. The method of claim 1, further comprising transmitting, by the computing system, at least one of: the healthcare skills data associated with the user, the health metric data, and the user-specific incentive for the prospective voyage to a computing device corresponding to a third party.

11. A computing system comprising:
memory; and
processing circuitry configured to:
receive a user interface request from a user device associated with a user including one or more parameters of a prospective voyage;
access the memory, wherein the memory stores healthcare skills data associated with the user and health metric data of one or more passengers associated with the prospective voyage;
apply a machine learning (ML) model to generate a risk score indicative of a likelihood that a medical emergency will occur during the prospective voyage, wherein the ML model is trained using one or more of in-voyage medical event management ratings from past voyages of particular users, need scores of the past voyages, or user-specific incentives of the past voyages;
determine, based on the risk score and the healthcare skills data associated with the user, a user-specific incentive for the prospective voyage; and
generate the travel-booking user interface for displaying the user-specific incentive.

12. (canceled)

13. The computing system of claim 11, wherein to apply the ML model to generate the risk score, the processing circuitry is configured to:
for each respective passenger of the one or more passengers associated with the prospective voyage:
collect one or more health metrics of the respective passenger; and
determine a passenger risk score of the respective passenger based on the health metrics of the respective passenger, wherein the passenger risk score corresponds to a likelihood that the respective passenger will experience a medical emergency during the prospective voyage; and
determine the risk score of the respective voyage based on the passenger risk scores of the one or more passengers associated with the prospective voyage.

14. (canceled)

15. The computing system of claim 11, wherein to determine the user-specific incentive for the prospective voyage, the processing circuitry is further configured to determine the user-specific incentive for the prospective voyage based at least in part on the healthcare skills data associated with the user, the health metrics of the one or more passengers associated with the prospective voyage, and applicable healthcare skills of one or more passengers associated with the prospective voyage.

16. The computing system of claim 11, wherein to determine the user-specific incentive for the prospective voyage, the processing circuitry is further configured to determine the user-specific incentive for the prospective voyage based at least in part on the healthcare skills data associated with the user, the health metric data of the one or more passengers associated with the prospective voyage, and applicable healthcare skills of one or more crew members of the prospective voyage.

17. The computing system of claim 11, wherein the processing circuitry is further configured to:
prior to receiving the user interface request, obtain the healthcare skills data associated with the user from the user;
store the healthcare skills data associated with the user in the memory; and
obtain the healthcare skills data associated with the user from the memory.

18. A non-transitory computer readable medium comprising instructions that, when executed, cause processing circuitry of a computing system to:
receive a user interface request from a user device associated with a user including one or more parameters of a prospective voyage;
access a memory, wherein the memory stores healthcare skills data associated with the user and health metric data of one or more passengers associated with the prospective voyage;
apply a machine learning (ML) model to generate a risk score indicative of a likelihood that a medical emergency will occur during the prospective voyage, wherein the ML model is trained using one or more of in-voyage medical event management ratings from past voyages of particular users, need scores of the past voyages, or user-specific incentives of the past voyages;
determine, based on the risk score the healthcare skills data, a user-specific incentive for the prospective voyage; and
generate the travel-booking user interface for displaying the user-specific incentive.

19. (canceled)

20. The non-transitory computer readable medium of claim 18, wherein to apply the ML model to generate the risk score, the instructions cause the processing circuitry to:
for each respective passenger of the one or more passengers associated with the prospective voyage:
collect one or more health metrics of the respective passenger; and
determine a passenger risk score for the respective passenger based on the health metrics of the respective passenger, wherein the passenger risk score for the respective passenger corresponds to a likelihood that the respective passenger will experience a medical emergency during the prospective voyage; and
determine the risk score for the prospective voyage based on the passenger risk scores for the one or more passengers.

21. The method of claim 1, wherein the machine learning model is a first machine learning model, and wherein determining the user-specific incentive for the prospective voyage comprises:
applying, by the computing system, a second machine learning model that determines the user-specific incentive for the prospective voyage based on the risk score and the healthcare skills data associated with the user, wherein the second machine learning model is trained using past user-specific incentives.

22. The method of claim 1, wherein the ML model comprises a neural network having two or more hidden layers, and wherein each respective hidden layer of the neural network includes a rectified linear unit function in each of one or more hidden layers of the neural network.

23. The computing system of claim 11, wherein the machine learning model is a first machine learning model, and wherein the processing circuitry is configured to, as part of determining the user-specific incentive for the prospective voyage:
apply a second machine learning model that determines the user-specific incentive for the prospective voyage based on the risk score and the healthcare skills data associated with the user, wherein the second machine learning model is trained using past user-specific incentives.

24. The computing system of claim 11, wherein the ML model comprises a neural network having two or more hidden layers, and wherein each respective hidden layer of the neural network includes a rectified linear unit function in each of one or more hidden layers of the neural network.
